(19) United States
(12) Patent Application Publication
(10) Pub. No.: US 2008/0063679 A1
(43) Pub. Date: Mar. 13, 2008

(54) NANOCOMPOSITES WITH RESIDUAL BIOCIDAL AND BIOSTATIC PROPERTIES

(75) Inventors: Reyad Sawafta, Greensboro, NC (US); Yousef Haik, Greensboro, NC (US); Wiley Hitchcock, Greensboro, NC (US); Venu Kuturu, Greensboro, NC (US); Irina CIubotaru, Greensboro, NC (US); Ye-Sun Lee, Greensboro, NC (US)

Correspondence Address: REYAD SAWFTA;QUARTEK CORP., 4180 PIEDMONT PARKWAY, GREENSBORO, NC, 27410, US

(73) Assignee: Quartek Corporation, Greensboro, NC (US)

(21) Appl. No.: 11/671,675

(22) Filed: Feb. 6, 2007

Related U.S. Application Data
(60) Provisional application No. 60/821,497, filed on Aug. 4, 2006.

(51) Int. Cl. A01N 25/34

(52) U.S. Cl. 424/411; 424/405

(57) ABSTRACT

We disclose novel classes of alloy nanocompositions that have superior decontaminant properties which are derived from their superior immediate and residual biocidal properties. By decontaminant properties it is understood that the preferred compositions are antiseptics, disinfectants, sanitizers, and/or sterilizers. By biocidal properties it is understood that the preferred compositions are excellent antimicrobials, antivirals, antifungals, and sporicidals. The preferred compositions have superior immediate and residual biocidal properties in free or bound form and they are safe to humans and environmental friendly. The nanocomposites described herein are in two element, three element or four element combinations. The preferred compositions have additional properties such as they are magnetic and/or they have distinct natural colors. The compositions are produced in different sizes ranging from 5 nm up to 500 nm, and for some other classes above 500 nm.

### CROSS-REFERENCE TO RELATED APPLICATIONS

This application claims the benefit of U.S. Provisional Application No. 60/821,497, filed on Aug. 4, 2006. The application is incorporated herein by reference in its entirety. Publications cited herein and the materials for which they are cited are specifically incorporated by reference. Modifications and variations of the methods and biocidal materials described herein will be obvious to those skilled in the art from the foregoing detailed description. Such modifications and variations are intended to come within the scope of the described biocidals in this document.

### SUMMARY OF THE INVENTION

We claim novel classes of metal alloy compositions which are used in particulate or ionic forms and display superior immediate and residual antibacterial, antiviral, antifungal, and sporicidal properties. The nanocomposites when applied free or bound to a matrix have immediate and long lasting biocidal effects when in contact with the microorganism. In another aspect of the current invention, the nanocomposites when applied free or bound to a matrix express residual biocidal activity over a long period of time after being removed from the contaminated site. Additionally and as needed, these particles may be synthesized in various size ranges (e.g. 5-100 nm, 100 nm-500 nm, or above 500 nm), various colors or with a potential to change their color, and/or as magnetic particles. These biocidal compositions are non-toxic to human cells and considered “green” to the environment. Depending on the application, these particles can be used as free particles in an aqueous suspension or in an emulsion, as well as immobilized in a matrix with a complete preservation of their biocidal properties. The latter approach is desirable in order to limit the environmental burden and comply with the regulatory specifications regarding the use of nanomaterials. Various matrices have been tested as a support for the herein disclosed biocidal particles, such as polymeric, cellulosic (paper, cardboard) and woven and non-woven materials.

Matrices loaded with biocidal nanocomposites retain the ability to kill microorganisms immediately and to prevent further contamination due to their excellent longevity of action and residual biocidal properties.

Biodegradable polymers and copolymers containing biocidal nanocomposites have been developed and tested and may have various applications such as, but not limited to, food packaging, cosmetics, feminine hygiene, construction, cleaning and sanitizing products, etc. Besides their function as a matrix and delivery system for the biocidal nanocomposites, these polymers may act as biocidal and/or biostatic materials as well as superabsorbents. These polymers can be in the form of particles that do not have a large ratio of greatest dimension to smallest dimension (e.g., granules, flakes, pulveralents, inter-particle aggregates, interparticle crosslinked aggregates, and the like), and/or the polymers can be in the form of fibers, sheets, films, foams, laminates, and the like. These polymers/copolymers can be designed as soft films or rigid and semi-rigid sheets that are water soluble on their own or with the help of a catalyst. Also they can be made in the form of a foam or sponge loaded with biocidal nanocomposites.

Cellulosic materials such as paper and cardboard can be loaded with the biocidal nanocomposites and used in areas such as, but not limited to, food packaging, preservation, construction, etc. Nanocomposites may be loaded into the matrix by mixing them with the pulp in the presence or absence of binders.

Woven and non-woven materials are excellent matrices for the biocidal nanocomposites with a wide array of applications such as, but not limited to, self-sterilizing textile, napkins, wipes, etc. Nanocomposites may be loaded into the matrix by mixing them with wood pulp, a blend of wood pulp, and/or synthetic fibers. In one aspect of this embodiment, the synthetic fibers include, but are not limited to, polyester, rayon, nylon, polypropylene, polyethylene, and/or cellulose polymers. Nanocomposites may be loaded into the matrix by mixing them with the pulp in the presence or absence of binders.

Combination of matrices can be to design complex biocidal systems for various applications. For example, a cleaning wipe that consists of a single or multiple layers may be designed to contain the biocidal nanocompositions for decontamination purposes. This wipe may contain one or more of the matrices described above. The absorbent capacity of the wipe may be modulated by the presence of a superabsorbent material (e.g. chitosan) and/or woven or non-woven materials. In one embodiment, the wipe includes, but is not limited to, a woven and/or a nonwoven material. In one aspect of this embodiment, the nonwoven material includes, but is not limited to, nonwoven, fibrous sheet materials. In another and/or alternative aspect of this embodiment, the nonwoven material includes, but is not limited to, meltblown, coform, air-laid, spun bond, wet laid, bonded-carded web materials, and/or hydroentangled (also known as spunlaced) materials. In still another and/or alternative aspect of this embodiment, the woven material includes, but is not limited to, cotton fibers, cotton/nylon blends and/or other textiles. Representative superabsorbent materials include, but are not limited to, water insoluble, water-swellable superabsorbent gelling polymers. Polymeric materials able to retain great amount of fluids are also commonly referred to as “hydrocolloids”, and can include, but are not limited to, polysaccharides such as carboxymethyl starch, carboxymethyl cellulose, and/or hydroxypropyl cellulose; nonionic types such as polyvinyl alcohol, and/or polyvinyl ethers; cationic types such as polyvinyl pyridine, polyvinyl morpholine, N, -dimethylaminoethyl and/or N, -diethylaminopropyl acrylates and/or methacrylates; anionic including carboxyl groups. These polymers can be used either solely or in the form of a mixture of two or more different polymers. In another aspect of this embodiment, the polymer materials used in making the superabsorbent gelling polymers typically are slightly network crosslinked polymers of partially neutralized polyacrylic acids and starch derivatives thereof.

The biocidal nanocomposition can be loaded onto such a cleaning wipe or used independent of it. The biocidal nanocomposites can be applied to decontaminate surfaces (animate and inanimate surfaces) as part of an absorbent or absorbent material that serves both as a delivery system for the biocidal agent and as a wiping material. The concept described for the cleaning wipe can be used to design absorbent other cleaning devices such as, but is not limited to, cleaning cloths, sponges (e.g., cellulose, synthetic, etc.), paper towels, napkins, rags, mop heads, cleaning pads, towels, brooms, etc.

In another aspect of the present invention the nanocomposites are applied to the surface prior to applying an absorbent and/or absorbent material to spread and wipe the surface with the nanocomposite solution. In this case, the biocidal nanocomposition is generally in a liquid, aerosol, solid, or semi-solid form and is applied to a surface to be cleaned prior to exposing the improved cleaning composition to an absorbent and/or adsorbent material and then wiped up by the absorbent and/or adsorbent material. The biocidal nanocomposition can be used by itself or combined with other decontaminant/cleaning formulations such as chlorine-releasing compounds (CRC, e.g. hypochlorite), biguanide (e.g. chlorhexidine), QACs, ionic liquids, surfactants, soaps, detergents, etc. Several approaches may be used if the combination of the biocidal nanocomposites and alternative cleaning formulations is desired. First, cleaning formulations may be mixed with the biocidal nanocomposite and applied to the surface to be cleaned prior to wiping. Second, the mixture of the cleaning formulation and biocidal nanocomposites can be delivered through the absorbent/absorbent material during wiping. Third, the biocidal nanocomposite is applied first and then the cleaning formulation delivered through the absorbent/absorbent material during wiping. Fourth, the cleaning formulation is applied first and then the biocidal nanocomposite is delivered through the absorbent/absorbent material during wiping. In this case, the biocidal nanocomposite will ensure the immediate killing of remaining microorganisms and a residual effect to prevent further contamination.

The use of the biocidal nanocomposites alone or in combination with cleaning formulations can be design to be user-friendly by preloading these agents in the absorbent/absorbent material or prepackaging them in concentrated or ready-to use solutions. Additionally, the preloaded absorbent wipes can be individually wrapped and sealed and made available for the consumer as stand-alone decontamination wipes or for the use with other cleaning tools (e.g. mops, brooms). These wipes could also be made available as one-use disposable wipe or washable and reusable wipe that maintains its biocidal properties for a preset number of washes.

The biocidal nanocomposites are intended to decontaminate both living tissues (i.e. antiseptic) and inanimate objects and surfaces (i.e. disinfectant) and as a sanitizer or sterilant. The former case refers to hands of the personnel in hospitals, urgent care facilities, clinics, nursing homes, medical/dental offices, laboratories restaurants, or in any facility where an there is an increased risk for infectious. The latter case refers to hard surfaces found indoors (homes, offices, laboratories, restaurants, hotels, entertainment areas, recreational areas, educational facilities, etc) and outdoors. In another embodiment the biocidal nanocomposites are applied in free or bound forms to swimming pools inlets and outlets, pool tops, flooring, water proofing, walls, filters, rails, hoses (flexible and rigid), pluming systems, drainage, water supply.

### BACKGROUND OF THE INVENTION

Decontamination is any activity that reduces the microbial load to prevent inadvertent contamination or infection. The appropriateness of a decontamination procedure is situational. Disinfection encompasses a continuum of outcomes in terms of the types of microorganisms destroyed. Microorganisms can be grouped as following in terms of decreasing resistance to disinfectants: bacterial endospores (B. subtilis, Clostridium spp); Mycobacteria; nonlipid or small viruses (poliovirus, rhinovirus); fungi; vegetative bacteria; and, lipid or medium sized virus (Herpes simplex, HIV, HBV).

Most widely used disinfectants are Alcohols (ethyl and isopropyl) 60-85%, Phenolics (0.4%-5%), Glutaraldehyde (2-5%), QACs (0.5-1.5%), Iodophors (30-1,000 ppm iodine), and Chlorine (100-1,000 ppm). Besides Gluteraldehyde that has a high disinfection level, all the other agents are low to medium disinfectants that are not efficient in killing spores, Mycobacteria, or fungi. Another drawback is the irritant nature of some of the efficient chemical disinfectants.

One type of biocide that has been used in cleaning solutions are the QACs. Although QACs are excellent biocides, they can cause skin irritation when used in high concentrations. QACs have a low release rate when bound in a matrix but 12% or more of isopropyl alcohol may be added to the matrix to enhance their release. It is preferable to reduce the amount of isopropyl alcohol to meet federal and state regulations. Due to the toxicity of quats, the amount to be impregnated in the matrix is also subjected to state and federal regulations.

QACs tend to leave residues and/or cause streaking after being applied to surfaces which reduces the consumer likeness of QAC-impregnated products. The streaking influence the judgment of the consumer as the surface is not clean. It additionally changes the reflections of the treated surface. An approach to improve the effectiveness of the QACs is the inclusion of a cationic solution along with the QACs as disclosed in U.S. Pat. Appl. 20060166849, however, the fundamental problem of irritation and long term biocidal influence is not solved.

Resistance of microorganisms to antimicrobial drugs has increased significantly in the past decades. According to the Centers for Disease Control and Prevention, nosocomial infections affect approximately 2 million people annually in the United States (U.S.) and are responsible for approximately 88,000 deaths per year. In addition to the lives lost, nosocomial infections add an estimated $5 billion to $6.7 billion to the U.S. healthcare costs. Infections related to indwelling medical devices are ranked as the fifth cause of hospital patient deaths in the U.S. and bio film formation is recognized as the leading culprit for their etiology. Other sources of hospital infections are the hands of medical personnel, surfaces, and poorly sanitized water supply and air conditioning systems. Transfusion of infected blood may occur without rigorously screening and preserving the blood in blood banks. With newly emerging pathogens and limited battery of antimicrobial tests this may have catastrophic consequences. The technology disclosed in this invention could offer a solution to this potential problem. Specifically, antimicrobial particles could be embedded in the plastic of the blood bags and ensure its sterility during storage. Alternatively, particles could be embedded in a matrix and used as a floating insert in the blood or as part of the delivery tubing system. Free biocidal magnetic particles could also be used and prevented from entering the body using a system of magnets inserted in the plastic bag or tubing system.

Food borne pathogens have also been identified as a major cause of illnesses for millions of people in the U.S. alone. Since the early 1990s, an increasing number of food-borne illnesses have been associated with fresh and minimally processed produce such as green onions (Hepatitis A virus), lettuce (Escherichia coli O157:H7), cantaloupes (Salmonella spp) and tomatoes (Listeria monocytogenes) (e.g. Frost et al. Emerg. Infect. Dis. 1(1): 26-29, (1995)). An increase in global trade, a longer food chain, exposure to exotic microflora, distribution to a larger population in more geographically dispersed areas, and an aging population that is susceptible to food-borne illness may all play a role in the increased number of food-borne illnesses that implicate fresh produce. For example, outbreaks of shigellosis in Norway, Sweden and the U.K. in 1994 were mainly due to contaminated lettuce imported from Southern Europe and cyclosporiasis in the U.S. was linked to consumption of contaminated raspberries imported from Guatemala. In developing countries, continued use of untreated wastewater and manure as fertilizers for the production of fruits and vegetables is a major contributing factor to contamination that causes numerous food-borne disease outbreaks.

Ensuring the safety of food and water supplies is one of the main concerns when it comes to biodefense since these are the easiest sectors that could become naturally or intentionally contaminated. The recent rise in bioterrorism has led the government to launch incentives for the development of new technologies to neutralize or combat the effects of potential environmental contaminants (i.e. chemical and biological agents). These technologies must be available to the U.S. public health system and primary healthcare providers to address various biological agents, including pathogens that are rarely seen in the U.S such as Bacillus anthracis, Clostridium botulinum, Yersinia pestis, and others.

Therefore, continuous efforts are being put forth for the discovery of efficient biocidal agents that can be used for safe decontamination and preservation of food stuff, for preventing microbial colonization and biofilm formation on surfaces of medical devices, and of other products made available to the consumer. Ideally, these agents will be able to fight the microorganisms but also be environmental friendly when disposed. The oligodynamic activity of metals provides a valuable alternative to the use of systemic antibiotics and/or disinfectants in certain situations. The biostatic/biocidal properties of metals ions such as silver, copper, and zinc are well-known. Modern technologies that employ metals for their antimicrobial effects show encouraging results in a variety of bacteria (E. coli, S. aureus, S. epidermidis, S. pneumoniae, P. aeruginosa), viruses (Herpes simplex, HIV, Nile virus), and fungi (A. niger, C. albicans). So far, metals ions have been used for this purpose under various forms, such as metal colloids (salts, oxides) or alloys.

The antimicrobial properties of metallic nanoparticles have not been extensively reported. Recent work conducted with silver showed that both metallic nanoparticles and ionic salt were activated in the presence of moisture, but metallic silver was active much longer than the ionic silver on microorganisms. Silver nanoparticles have also been tested for their antimicrobial properties when used as impregnated into a polymer, in coating, or in wound dressing as described in U.S. Pat. No. 6,866,859 and its incorporated references. Although silver seems to be the favorite antimicrobial metal, there are several shortcomings associated with its use. Most importantly, silver has a short term antimicrobial activity that requires its continuous reapplication and also the fact that in order to display this effect silver requires an aqueous environment that produces the active ionic form. Bacterial resistance to silver has also been reported. Studies have also examined the oligodynamic properties of other metals, including gold, cobalt, nickel, titanium, iron, and vanadium as described in U.S. Pat. No. 7,001,452. Data on the antimicrobial properties of these alloys in a nanoparticulate form is not available. Limited data which are available with regard of these metals or metal alloys suggest that these agents may have biocidal activity against a wide array of bacteria, fungi, and protozoa. The precise antimicrobial effects depend on the metal of interest, environmental conditions, and the pathogens being targeted.

Although the broad assumption of increased toxicity for nanoscale materials is not unanimously supported by evidence, existing and emerging regulatory specifications have been increasingly addressing the importance of size when it comes to nanomaterials. Therefore it would be desirable to provide improved nanoparticles compositions that can be used for their superior biocidal properties and at the same time remain safe to the user and environment.

Current antimicrobials have a short life with no residual effect. They lose there effectiveness in high protein environment. Certain bacteria developed resistance. They are toxic or cause irritations. Some are highly corrosive. A comparison between the existing products with the nanocompositions presented in this invention is shown in table 1.

TABLE 1
Comparison between the biocidal nanocomposites and existing
decontaminants

| | Hypochlorite | Quats | Nanocomposites |
|---|---|---|---|
| Minimum inhibitory | 150 ug/ml | >50–78 ug/ml | 7 ug/ml QNM1 |
| concentration (MIC) | | | 1 ul/ml QNM2 |
| Effectiveness | | | |
| Bactericidal | very good | Good (not always | very good |
| (G+ & G−) | | on P. aeruginosa) | |
| Sporicidal | no/fair | no | Yes |
| | (↑ conc) | | |
| Fungicidal | good | no | Yes |
| Effective in organics | poor | poor | Good |
| Effective in | poor | no | Good |
| hard water | | | |
| Effective in soap | yes | no | Yes |
| pH | 6–7 | 8–11 | wide range |
| Contact time | 1–30 min | 1–30 min | 1–30 min |
| | (↑ conc) | | |
| Life-time | 2 h | 30 min | Weeks |
| Residual activity | poor | fair | Excellent |
| Odorless | no | yes | Yes |
| Non-staining | bleaching | yes | Yes |
| Non-corrosive | no | yes | Yes |

### BRIEF DESCRIPTION OF THE FIGURES

FIG. 1 is a graph showing a comparison between the immediate biocidal effects of nanocomposites with QACs, at concentrations close to their MIC levels in a high protein media. The nanocomposites and QACs were incubated at concentrations ranging from 2 ul to 100 ul with 0.5×10⁶ E. coli O157:H7 for 1 minutes and 5 minutes, respectively, are At MIC level the immediate biocidal effect of nanocomposites is far more superior than QACs.

FIG. 2 shows the longevity of the biocidal effect of the nanocomposites compared to that of QACs in a high protein environment. Both agents were impregnated in an absorbent material which was then placed on top of an agar plate that had been inoculated with 0.5×10⁶ E. Coli O157:H7. The agar plate was incubated for 18 hours to allows for bacterial growth. The size of the inhibition zone around the treatment area suggests that the nanocomposites have a greater biocidal effect than QACs after 24 h.

FIG. 3 shows the immediate biocidal effect of nanocompositions impregnated onto a napkin compared to that of QACs from a commercial sanitizing wet wipe after 30 seconds of application. Both nanocomposites and QACS have immediate biocidal effect.

FIG. 4 shows the residual effect that nanocomposites have in killing E. coli O157:H7 up to 24 after the removal of a napkin containing embedded nanocomposites. The residual effect was assessed at at 1h, 2h, and 24h. Other experiments

were conducted showing residual effect of several days depending on the dose of nanocomposites loaded into the napkin (data not shown).

FIG. 5 is a graph illustrating the sporicidal and fungicidal effect of nanocomposites and QACs. The nanocomposites are far more potent than QACs.

FIG. 6 is a graph illustrating the longevity of the sporicidal and fungicidal effect of the nanocomposites compared to that of the biguanide agent Chlorhexidine. The nanocomposites are far more potent than Chlorhexidine and this effect is maintained up to 3 months of incubation.

### DESCRIPTION OF THE INVENTION

The present invention is related to nanocomposite alloys with superior immediate and residual biocidal properties. In particular, nanoparticles have been developed that have immediate and residual biocidal effect on several classes of pathogenic bacteria, fungi, and viruses. Different classes of particles have been produced by varying the elemental composition of the alloys, the elemental ratios within the same alloy, or by changing parameters in the synthesis process.

There are main advantages that the disclosed technology has over currently available biocidal agents:

First, these particles are versatile for a number of applications, be it in a free or bound form. In one embodiment for the biocidal particles, the particles are administered at the site of decontamination in a free form (e.g. suspension, aerosol, and emulsion) or imbedded in a suitable material such as a polymer, paper, or woven or non-woven matrices (e.g. tissue, napkin, wipe, textile, etc). In a preferred embodiment it is specified that the matrices are used to ensure the delivery of the biocidal agent to the surface to be decontaminated. These matrices are polymers (e.g. films, foams, in both flexible and rigid forms, hydrogels), cellulosic structures (e.g. paper, cardboard), and woven or non-woven fabric matrix. In another embodiment it is specified that some matrices are used to ensure the longevity of the biocidal effect of the particles. In another embodiment it is specified that some matrices provide additional biocidal/biostatic properties to those showed by the nanocomposites.

Second, by controlling their elemental composition, the residual biocidal properties of the nanocomposites can be significantly enhanced.

Third, by controlling their elemental composition, the immediate effectiveness and longevity of their biocidal properties can be significantly enhanced.

Fourth, these biocidal nanocomposites can be used together with other conventional disinfectants (e.g. sodium hypochlorite, chlorhexidine digluconate, quaternary ammonium salts) to enhance their potency.

Fifth, these particles are effective in high protein media, hard liquids such as hard water where most of the common disinfectants become ineffective.

Sixth, these particles remain active over a broad pH range compared to other common disinfectants.

Seventh, additional physical and chemical and biological properties can be added to the biocidal particles depending on the application requirement.

Eighth, these compositions are more effective as alloys compared to mixtures of individual components.

Nine, at the dose required for an immediate and prolonged biocidal effects, the disclosed nanocomposites are non-toxic, non-irritant, non-corrosive and as much or more cost-effective than existent decontaminants.

Ten, the biocidal nanocomposites exhibit superior biocidal properties compared to other disinfectants when used at or near MIC levels.

The biocidal nanocomposites are can be provided in a liquid, aerosol, solid, or semi-solid form. The compositions described in this application can be used on their own or combined with other decontaminate/cleaning formulations. The compositions described in this application can be provided as loaded onto an absorbent and/or absorbent material, and/or separately from an absorbent and/or absorbent material. The absorbent and/or absorbent material includes, but is not limited to, cleaning wipes, cloths, sponges (e.g., cellulose, synthetic, etc.), paper towels, napkins, rags, mop heads, cleaning pads, towels, brooms, other absorbent tools, and/or the like.

In a preferred embodiment it is mentioned that color and magnetic properties can be found in the described nanocomposites in addition or independent of their biocidal properties.

In a preferred embodiment the magnetic property of novel compositions they are retrievable and recyclable. Additionally they maintain superior biocidal property for multiple usage applications.

In another preferred embodiment the biocidal nanocomposites possess magnetic properties that can be influenced by an applied magnetic field.

In another preferred embodiment the magnetic biocidal nanocomposites have a wide range of Curie temperatures.

In another preferred embodiment the biocidal nanocomposites have a natural color that is specific to the composition.

Finally, these nanocomposites are designed to be non-irritant and safe for the consumer and environmental friendly. In a preferred embodiment, the biocidal nanomaterial is in the form of nanoparticles, provided in a biocompatible form which is desirable to provide a safeguard for the environment.

As used herein, the terms “comprise,” “comprising,” “include,” and “including” are intended to be open, non-limiting terms, unless the contrary is expressly indicated.

As used herein, the term “composition” is intended to be used for alloys that have two or more elements or combinations of alloys that are produced by a preferred technique as described herein and has preferred biocidal properties and they have a size above 5 nm.

As used herein, the term “nanocomposites” and the term “nanoparticles” are used to describe alloys that have two or more elements or combination of alloys that produced by a preferred technique as described herein and have preferred biocidal properties.

As used herein, the terms “biocidal”, “nanocidal”, “biocidal nanoparticles” are intended to be used as antimicrobial, antibacterial, antifungal, antialgae, antiviral, sporicidal and other pathogenic organisms. The broad biocidal spectrum includes Gram+ and Gram− bacteria, spore and non-spore forming bacteria, viruses, vegetative and non-vegetative fungi, yeast, protozoa, and other microorganisms.

As used herein, the terms “nanocomposites”, “nanoparticles”, “particles” and “nanomaterials” are intended to be used for structure of any shape and composition with dimensions between 5-2000 nm.

### The Composition

In one embodiment particles made of two or more element alloys have superior biocidal properties compared to one element particles. For example but not limited to these compositions, CuAg and CuCoAg particles were more bactericidal than a mixture of particles made of Cu, Co, or Ag alone and used in similar proportion as in the alloys.

In one embodiment a combination of transition metals 3d of the periodical table such as Chromium or Manganese or Iron or Cobalt or Nickel or Copper or Zinc or 4d Silver or 5d Gold, or rare earth metals from the lanthanides such as Cerium, or Neodymium, or Samarium, or Gadolinium, or Terbium, or Dysprosium, or Holmium, or Erbium, or alkali metals such as Lithium, or Sodium, or Potassium, or Magnesium, or Calcium in a binary or tri or quad combination with different percentages will compose a preferred biocidal nanoparticle class.

In one preferred embodiment the metal alloy composition is in the form LₐM_{b}N_{c}Q_{d}, where (L) is a metal that has a dominant percentage in the formulation. (L) can be one of the following metals, Chromium or Manganese or Iron or Cobalt or Nickel or Copper or Zinc, or Silver or Gold, or a rare earth material such as Cerium, or Neodymium, or Samarium, or Gadolinium, or Terbium, or Dysprosium, or Holmium, or Erbium, or Lithium or Sodium, or Potassium, or Magnesium, or Calcium. (M) is one of the elements described above under (L) but except the dominant element for the specific combination. (N) is one of the elements described above under (L) including the element that is dominant for the specific combination. (Q) is one of the elements described above under (L) including the element that is dominant for the specific combination. The proportion of elements in each composition is indicated by a, b, c, and d where a can vary from 26%-99.7%, b can vary from 0.1-49.8%, c can vary from 0.1-49.8% and d can vary from 0.1-49.8%.

In another sub-embodiment the composition have three elements in the alloy composition in the form LₐM_{b}N_{c} where (L) is the dominant element in the composition. (L) is one of the following metals, Chromium or Manganese or Iron or Cobalt or Nickel or Copper or Zinc, or Silver or Gold, or a rare earth material such as Cerium, or Neodymium, or Samarium, or Gadolinium, or Terbium, or Dysprosium, or Holmium, or Erbium, or Lithium. (M) is any one of the elements described above under (L) but except the dominant element for the specific combination. (N) is one of the elements described above under (L) including the element that is dominant for the specific combination. The proportion of elements in each composition is indicated by a, b, and c where a can vary from 34%-99.8%, b can vary from 0.1-49.9%, c can vary from 0.1-49.9%.

In another sub-embodiment the alloy composition have two elements in the form LₐM_{b} where (L) is the dominant element in the alloy composition. (L) is one of the following metals, Chromium or Manganese or Iron or Cobalt or Nickel or Copper or Zinc, or Silver or Gold, or a rare earth material such as Cerium, or Neodymium, or Samarium, or Gadolinium, or Terbium, or Dysprosium, or Holmium, or Erbium, or Lithium. (M) is one of the elements described above under (L) but except the dominant element for the specific combination. The proportion of elements in each composition is indicated by a and b, where a can vary from 50%-99.9%, b can vary from 0.1-50

In one preferred embodiment, a composition is synthesized where Copper is a dominant element in the composition of the form CuₐM_{b}N_{c}Q_{d}, where a, b, c and d are the proportion of the elements in the composition of the nanoparticles. (M), (N) and (Q) are other elements used in the composition. In a preferred sub-embodiment, (M) can be one of the following metals, Chromium or Manganese or Iron or Cobalt or Nickel or Zinc, or Silver or Gold, or a rare earth material such as Cerium, or Neodymium, or Gadolinium, or Terbium, or Dysprosium Erbium, or Holmium, or Samarium, or Lithium. (N) is one of the elements described above under (M) but also Copper. (Q) is one of the elements described above under (M) but also Copper. In this composition, a is varying from 26%-99.7%, b varying from 0.1-49.8%, c varying from 0.1-49.8% and d varying from 0.1-49.8%). As examples for this embodiment are Cu₅₅Co₁₅Ni₁₅Ag₁₅, Cu₆₀Ni₂₀Dy₁₀Zn₁₀, Cu₆₀Ni₂₀Dy₁₀Li₁₀, Cu₆₀Ni₂₀Ho₁₀Li₁₀, Cu₆₀Ni₂₀Co₁₀Zn₁₀, Cu₆₀Ni₂₀Co₁₀Li₁₀.

In another preferred sub-embodiment the composition have three elements in the composition where Copper remains the dominant element in the composition in the form CuₐM_{b}N_{c}. In a preferred sub-embodiment, (M) is one of the following metals, Chromium or Manganese or Iron or Cobalt or Nickel or Zinc, or Silver or Gold, or a rare earth material such as Cerium, or Neodymium, or Samarium, or Gadolinium, or Terbium, or Dysprosium, or Holmium, Erbium, or Lithium. (N) is one of the elements described above under (M) but also Copper. In this composition, a is varying from 34%-99.8% and b is varying from 0.1%-49.9% and c is varying from 0.1-49.9%. As examples for this embodiment are Cu₇₀Co₁₅Ag₁₅, Cu₇₀Ni₁₅Ag₁₅, Cu₇₀Li₁₅Ag₁₅, Cu₇₀Ni₁₅Li₁₅, Cu₇₀Co₁₅Li₁₅, Cu₅₀Ho₂₀Mn₃₀.

In another preferred sub-embodiment where the composition have two elements where Copper is a dominant element in the form CuₐM_{b} where (M) is one of the following elements, Chromium or Manganese or Iron or Cobalt or Nickel or Zinc, or Silver or Gold, or a rare earth material such as Cerium, or Neodymium, or Samarium, or Gadolinium, or Terbium, or Dysprosium, or Holmium, or Erbium, or Lithium. In this composition, a is varying from 50-99.9%) and b is varying from 0.1-50%). As preferred examples for this embodiment are Cu₇₀Ni₃₀, Cu₇₀Zn₃₀, Cu₇₀Co₃₀, Cu₈₅Ag₁₅, Cu₇₀Li₃₀.

In one preferred embodiment, a composition is synthesized where Zinc is a dominant element in the composition of the form ZnₐM_{b}N_{c}Q_{d}, where a, b, c and d are the proportion of the elements in the composition of the nanoparticles. (M), (N) and (Q) are other elements used in the composition. In a preferred sub-embodiment, (M) is one of the following metals, Chromium or Manganese or Iron or Cobalt or Nickel or Copper or Silver or Gold, or a rare earth material such as Cerium, or Neodymium, or Samarium, or Gadolinium, or Terbium, or Dysprosium, or Holmium, or Erbium, or Lithium. (N) is one of the elements described above under (M) but also Zinc. (Q) is one of the elements described above under (M) but also Zinc. In this composition, a is ranging from 26-99.7%, b ranging from 0.1-49.8%, c ranging from 0.1-49.8% and d ranging from 0.1-49.8%.

In another preferred sub-embodiment the composition have three elements in the composition where Zinc remains the dominant element in the composition in the form ZnₐM_{b}N_{c}. In a preferred sub-embodiment, (M) is one of the following metals, Chromium or Manganese or Iron or Cobalt or Nickel or Copper, or Silver or Gold, or a rare earth material such as Cerium, or Neodymium, or Samarium, or Gadolinium, or Terbium, or Dysprosium, or Holmium, or Erbium, or Lithium. (N) is one of the elements described above under (M) but also Zinc. In this composition, a is varying from 34%-99.8% and b is varying from 0.1%-49.9% and c is varying from 0.1-49.9%.

In another preferred sub-embodiment where the composition have two elements where Zinc is a dominant element in the form ZnₐM_{b} where (M) is one of the following elements, Chromium or Manganese or Iron or Cobalt or Nickel or Copper, or Silver or Gold, or a rare earth material such as Cerium, or Neodymium, or Samarium, or Gadolinium, or Terbium, or Dysprosium, or Holmium, or Erbium, or Lithium. In this composition, a is varying from 50-99.9% and b is varying from 0.1-50%.

In another embodiment, the magnetic nanoparticles comprise a Mn—Zn Ferrite, having the formula: ZnₓMn₍₁₋ₓ₎Fe₂O₄ where x is between _{—}0.6_ and _{—}0.8. In one particular embodiment, the nanoparticles comprise a Gd-substituted Mn—Zn-Ferrite. In a particular embodiment, the ferrite has the composition Mn_{0.5}Zn_{0.5}GdₓFe₍₂₋ₓ₎O₄, where x is between 0 and 1.5. In another embodiment the Iron has a composition of Fe₍₁₋ₓ₎ZnₓFe₂O₄ where x is between 0.7 and 0.9, in another embodiment the combination was in the form of ZnFe₂O₄ in another embodiment the combination was in the form of ZnGdₓFe₍₂₋ₓ₎O₄ where x between 0.01 and 0.8.

In one preferred embodiment, a composition is synthesized where Manganese is a dominant element in the composition of the form MnₐM_{b}N_{c}Q_{d}, where a, b, c, and d are the proportion of the elements in the composition of the nanoparticles. (M), (N) and (Q) are other elements used in the composition. In a preferred sub-embodiment, (M) is one of the following metals, Chromium or Iron or Cobalt or Nickel or Copper or Zinc or Silver or Gold, or a rare earth material such as Cerium, or Neodymium, or Samarium, or Gadolinium, or Terbium, or Dysprosium, or Holmium, or Erbium, or Lithium. (N) is one of the elements described above under (M) but also Manganese. (Q) is one of the elements described above under (M) but also Manganese. In this composition, a is ranging from 26-99.7%, b ranging from 0.1-49.8%, c ranging from 0.1-49.8% and d ranging from 0.1-49.8%.

In another preferred sub-embodiment the composition have three elements in the composition where Manganese remains the dominant element in the composition in the form MnₐM_{b}N_{c}. In a preferred sub-embodiment, (M) is one of the following metals, Chromium or Iron or Cobalt or Nickel or Copper or Zinc or Silver or Gold, or a rare earth material such as Cerium, or Neodymium, or Samarium, or Gadolinium, or Terbium, or Dysprosium, or Holmium, or Erbium, or Lithium. (N) is one of the elements described above under (M) but also Manganese. In this composition, a is varying from 34%-99.8% and b is varying from 0.1%-49.9% and c is varying from 0.1-49.9%.

In another preferred sub-embodiment where the composition have two elements where Manganese is a dominant element in the form MnₐM_{b} where (M) is one of the following elements, Chromium or Iron or Cobalt or Nickel or Zinc or Silver or Gold, or a rare earth material such as Cerium, or Neodymium, or Samarium, or Gadolinium, or Terbium, or Dysprosium, or Holmium, or Erbium, or Lithium. In this composition, a is varying from 50-99.9% and b is varying from 0.1-50%.

In one preferred embodiment, a composition is synthesized where Silver is a dominant element in the composition of the form AgₐM_{b}N_{c}Q_{d}, where a, b, c, and d are the proportion of the elements in the composition of the nanoparticles. (M), (N) and (Q) are other elements used in the composition. In a preferred sub-embodiment, (M) is one of the following metals, Chromium or Manganese or Iron or Cobalt or Nickel or Copper or Zinc or Gold, or a rare earth material such as Cerium, or Neodymium, or Samarium, or Gadolinium, or Terbium, or Dysprosium, or Holmium, or Erbium, or Lithium. (N) is one of the elements described above under (M) but also Silver. (Q) is one of the elements described above under (M) but also Silver. In this composition, a is ranging from 26-99.7%, b ranging from 0.1-49.8%, c ranging from 0.1-49.8% and d ranging from 0.1-49.8%.

In another preferred sub-embodiment the composition have three elements in the composition where Silver remains the dominant element in the composition in the form AgₐM_{b}N_{c}. In a preferred sub-embodiment, (M) is one of the following metals, Chromium or Manganese or Iron or Cobalt or Nickel or Copper or Zinc or Gold, or a rare earth material such as Cerium, or Neodymium, or Samarium, or Gadolinium, or Terbium, or Dysprosium, or Holmium, or Erbium, or Lithium. (N) is one of the elements described above under (M) but also Silver. In this composition, a is varying from 34%-99.8% and b is varying from 0.1%-49.9% and c is varying from 0.1-49.9%.

In another preferred sub-embodiment where the composition have two elements where Silver is a dominant element in the form AgₐM_{b} where (M) is one of the following elements, Chromium or Manganese or Iron or Cobalt or Nickel or Zinc or Gold, or a rare earth material such as Cerium, or Neodymium, or Samarium, or Gadolinium, or Terbium, or Dysprosium, or Holmium, or Erbium, or Lithium. In this composition, a is varying from 50-99.9% and b is varying from 0.1-50%).

In one preferred embodiment, a composition is synthesized where Lithium is a dominant element in the composition of the form LiₐM_{b}N_{c}Q_{d}, where a, b, c and d are the proportion of the elements in the composition of the nanoparticles. (M), (N) and (Q) are other elements used in the composition. In a preferred sub-embodiment, (M) is one of the following metals, Chromium or Manganese or Iron or Cobalt or Nickel or Copper or Zinc or Silver or Gold, or a rare earth material such as Cerium, or Neodymium, or Samarium, or Gadolinium, or Terbium, or Dysprosium, or Holmium, or Erbium. (N) is one of the elements described above under (M) but also Lithium. (Q) is one of the elements described above under (M) but also Lithium. In this composition, a is ranging from 26-99.7%, b ranging from 0.1-49.8%, c ranging from 0.1-49.8% and d ranging from 0.1-49.8%.

In another preferred sub-embodiment the composition have three elements in the composition where Lithium remains the dominant element in the composition in the form LiₐM_{b}N_{c}. In a preferred sub-embodiment, (M) is one of the following metals, Chromium or Manganese or Iron or Cobalt or Nickel or Copper or Zinc or Silver or Gold, or a rare earth material such as Cerium, or Neodymium, or Samarium, or Gadolinium, or Terbium, or Dysprosium, or Holmium, or Erbium. (N) is one of the elements described above under (M) but also Lithium. In this composition, a is varying from 34%-99.8% and b is varying from 0.1%-49.9% and c is varying from 0.1-49.9%.

In another preferred sub-embodiment where the composition have two elements where Lithium is a dominant element in the form LiₐM_{b} where (M) is one of the following elements, Chromium or Manganese or Iron or Cobalt or Nickel or Zinc or Silver or Gold, or a rare earth material such as Cerium, or Neodymium, or Samarium, or Gadolinium, or Terbium, or Dysprosium, or Holmium, Erbium. In this composition, a is varying from 50-85% and b is varying from 15-50%.

In another sub-embodiment the nanoparticles are also magnetic and may comprise Iron or Nickel or Cobalt or Gadolinium or Manganese or Cerium, or Neodymium, or Terbium, or Dysprosium, or Holmium, or Erbium and/or their alloys. In one embodiment, the nanoparticles of the composition comprise an alloy of Copper and Nickel. In a particular embodiment, the alloy is 71 to 71.4 wt % Nickel, with the balance consisting essentially of Copper.

As used herein, the term “magnetic nanoparticles” includes magnetic, paramagnetic, superparamagnetic ferromagnetic and ferrimagnetic materials. The nanoparticles can have any essentially composition that has the preferred biocidal effect and that can be effectively applied at the site of treatment.

In another embodiment the composition is made such that it has a preferred natural color obtained naturally through the synthesis process of the particles, these colors range from blue to red in the visible spectrum.

In another embodiment the nanoparticles preferably have an effective mean diameter of between 5 nm and 500 nm, although it certain applications it may be suitable or desirable to have larger nanoparticles. In one embodiment, the nanoparticles have an average diameter greater than about 5 nm and less than 50 nm (e.g., 5-50 nm). In another embodiment, the nanoparticles have an average diameter greater than about 5 nm and less than 100 nm (e.g., 5-100 nm). In another embodiment, the nanoparticles have an average diameter greater than about 50 nm and less than 100 nm (e.g., 50-100 nm). In another embodiment, the nanoparticles have an average diameter greater than about 100 nm and less than 350 nm (e.g., 100-350 nm). In another embodiment, the nanoparticles have an average diameter greater than about 100 nm and less than 500 nm (e.g., 100-500 nm). In another embodiment, the nanoparticles have an average diameter greater than about 100 nm and less than 1000 nm (e.g., 100-1000 nm). In another embodiment, the nanoparticles have an average diameter greater than about 5 nm and less than 1000 nm (e.g., 5-1000 nm).

The nanoparticles preferably are administered in an acceptable carrier. In one embodiment, the particles with the preferred biocidal effect are mixed into a liquid suspension or are encapsulated into microcapsules, which may then be mixed with a suitable biocompatible medium. For example, the particles can be bound in a matrix material to form a microcapsule. Important properties of microcapsules are their density and their diameter.

In one embodiment, the composition includes a polymeric material. For example, the nanoparticles can be dispersed in or encapsulated by a biocompatible polymer. The term “polymeric” is understood to mean that the composition comprises one or more monomers, oligomers, polymers, copolymers, or blends thereof. Examples of polymers include polyvinyl alcohol, poly ethylene glycol, ethyl cellulose, polyolefins, polyesters, nonpeptide polyamines, polyamides, polycarbonates, polyalkenes, polyvinyl ethers, polyglycolides, cellulose ethers, polyvinyl halides, polyhydroxyalkanoates, polyanhydrides, polystyrenes, polyacrylates, polymethacrylates, polyurethanes, polypropylene, polybutylene terephthalate, polyethylene terephthalate, nylon 6, nylon 6,6, nylon 4,6, nylon 12, phenolic resins, urea resins, epoxy resins, silicone polymers, polycarbonates, polyethylene vinylacetate, polyethylene ethyl acrylate, polylactic acid, polysaccharides, polytetrafluoroethylene, polysulfones and copolymers and blends thereof.

In one embodiment the polymeric material is biocompatible, and preferably biodegradable. Examples of suitable polymers include ethylcelluloses, polystyrenes, poly(ε-caprolactone), poly(d,l-lactic acid), polysaccharides, and poly(d,l-lactic acid-co-glycolic acid). The polymer is preferably a copolymer of lactic acid and glycolic acid (e.g., PLGA, PVA or Chitosan).

### Methods of Making the Nanocomposites

The biocidal nanocomposites can be made by essentially any process that yields the appropriate composition for the materials of construction. In one technique, the nanoparticles are made by a mechanical/physical size reduction process. In another technique a co-precipitation process is used to make the biocidal nanoparticles. Preferably, the production process optimizes characteristics of the nanoparticles that influence the nanoparticles biocidal effectiveness.

In the mechanical methods the particles are formed by crushing or grinding or ball milling alloyed material made by melting of two or more metals in the preferred compositions as described before. The fine composition is then sorted by size using a centrifugation or magnetic separation techniques. In another embodiment the alloys are formed using pulse laser deposition technique. A powder of the preferred composition is billeted using a compression technique; the billeted composition is then subjected to a pulse laser with sufficient energy to evaporate the alloy. The evaporated material is then collected on substrate in the form of a thin film. The thin film is then broken down to nanoparticulates using high energy sonication or grinding or ball milling. The fine particles are further sorted by a settling gradient technique. Techniques such chemical vapor deposition can also be used to produce the films and then to further processing to have particles of the preferred composition.

In another embodiment the nanoparticles are synthesized by a chemical process. Chemical techniques have an advantage over physical methods because of the higher controllability of the size and the composition at the molecular levels.

In another embodiment the nanoparticles are synthesized using green methods such as but not limited to super critical fluids and enzyme reduction methods.

### Methods of Using the Composition

Generally, the method includes placing the biocidal material having a selected composition at a site intended for decontamination or sanitation or preservation (e.g. aqueous solution, a contaminated structure, foodstuff, cosmetics) or treatment (e.g. wounds, lesions). The nanocomposites reported in this application showed a strong biocidal effect when used alone in suspension, in a spray, or immobilized into a matrix (e.g. polymer, superabsorbent, paper, woven and/or non-woven materials, etc).

In one embodiment of the present invention, the nanocompositions are applied to a surface to be disinfected then an absorbent and/or absorbent material can be used to spread and wipe the solution on the surface. In another embodiment the nanocompositions are pre-applied to the absorbent and/or absorbent material. The biocidal compositions can be packaged to be used alone or in combination with other disinfectant or cleaning solutions and/or absorbent or adsorbent materials. The nanocompositions are typically formulated to sanitize hard surfaces such as, but not limited to, counter tops; floor; rug; bathroom fixtures and surfaces, kitchen surfaces and appliances, furniture surfaces, utility devices, automobiles, bicycles, motorcycles, yard and farm equipments, washing equipment, medical and/or dental equipment, marine equipment, toys, telephones, remote controls, books, writing implements, watches, framed pictures or paintings, painting equipment, and/or the like.

The biocidal nanocompositions can be in concentrated form or unconcentrated form (e.g., ready to use form). When the biocidal nanocompositions are not first impregnated on an absorbent or adsorbent material, the improved cleaning composition can be dispensed and/or sprayed as liquid from a container, as an aerosol from an aerosol container, or as a crystal, powder, paste, or otherwise semi-solid or solid form from a container.

The colored biocidal nanocomposites described in this application can be added to surfaces or fabrics or fibers to enhance or modify their aesthetic properties and at the same time maintain antimicrobial and antifungal properties at the surface.

The biocidal nanocomposites can be added to conduits and surfaces used for passing air and or liquids.

The nanocomposites described in this application can be added to soil or indoor/outdoor structures to eliminate or prevent the manifestation of microbial or fungal colonies without causing harmful effect to pets, environment or human.

The biocidal nanocomposites described in this application can be impeded into food containers or wraps or packages or storage devices to prevent formation of microbial or fungal colonies.

The biocidal nanocomposites described in this application are advantageous over chemical antimicrobial agents. The nanocomposites do not produce chemical vapors that are harmful to users.

The biocidal nanocomposites described in this application can be added to building materials and construction products such as but not limited to wall boards, tiles, wood, flooring and ceiling and wall paper materials to prevent the manifestation of microbial or fungal colonies without causing harmful effect to pets, environment or human.

The biocidal nanocomposites described in this application can be used together with other conventional disinfectants (e.g. sodium hypochlorite, chlorhexidine digluconate, quaternary ammonium salts) to enhance their potency.

The biocidal nanocomposites described in this application can be used as preservatives for paint and paint products, creams and lotions and other cosmetic products, shampoos and other cleaning products.

The biocidal nanocomposites described in this application can be used in house and office hold appliances such as but not limited to vacuum cleaners, air freshener devices, humidifiers, refrigerators, washers and dryers, cutting boards, sponges, showers and toilet cleaners.

The biocidal nanocomposites described in this application can be used to eliminate and prevent odor in applications such as but not limited to sport wear, military uniform, socks and under garments, shoes, air conditioning ducts and devices.

The biocidal nanocomposites described in this application can be used to coat medical devices such as but not limited to catheters and implants and to clinical and hospitals table tops, floors, sinks and boards.

The biocidal nanocomposites described in this application can be used in restaurants, kitchens, tables, cutting boards and cleaning tools.

The biocidal nanocomposites described in this application can be used in cars, mats, dashboards and seats.

The nanocomposites may in the form of a liquid, which can be applied to the target surface as a liquid spray, as an aerosol spray, or as a pour-on liquid, which can be poured onto a target surface or painted on the surface with the help of a fiber made out of woven or non-woven, paper, tissue, sponge, foam or brush element. Another mode is to impregnate the nanocomposites into a substrate made out of polymeric or non-polymeric material.

### EXAMPLE 1

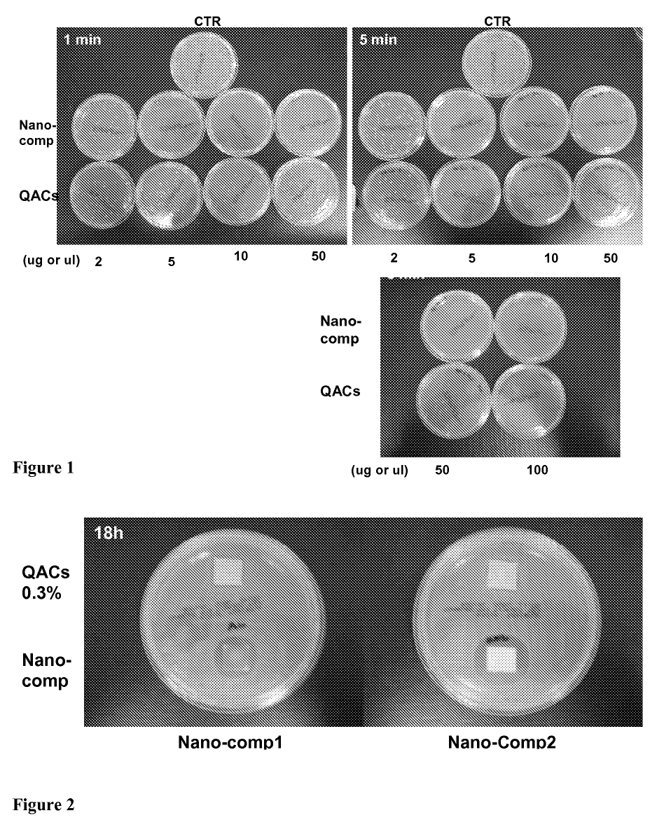

A comparison study of the immediate biocidal effect of nanocomposites and QACs was performed using the decontaminants at concentrations close to their MIC (Minimum Inhibitory concentrations). MIC found for the nanocomposites was 2 ul whereas the MIC for QACs was 0.5 μg/ml. The bacterial model was E. coli O157:H7. The study used 2, 5, 10, 50, 100 ul of nanocomposites solution and 2, 5, 10, 50, 100 microgram of QACs obtained from a Clorox wet wipe (0.3%). In practice 2000 ug/ml of QACs are typically applied in the wipe (60 folds higher than the MIC). The treatment time utilized in the experiments was 1 and 5 minutes. The disinfectant was incubated with 0.5×10⁶ bacteria. After the treatment for 1 and 5 minutes, the bacteria were grown on agar overnight. Colony count was utilized to measure the effectiveness of the disinfectant. FIG. 1 shows the results obtained. It is clearly shown that the nanocomposites have far more biocidal action than those of QACs at 1 and 5 minutes incubations at similar fold increase in their MIC.

### EXAMPLE 2

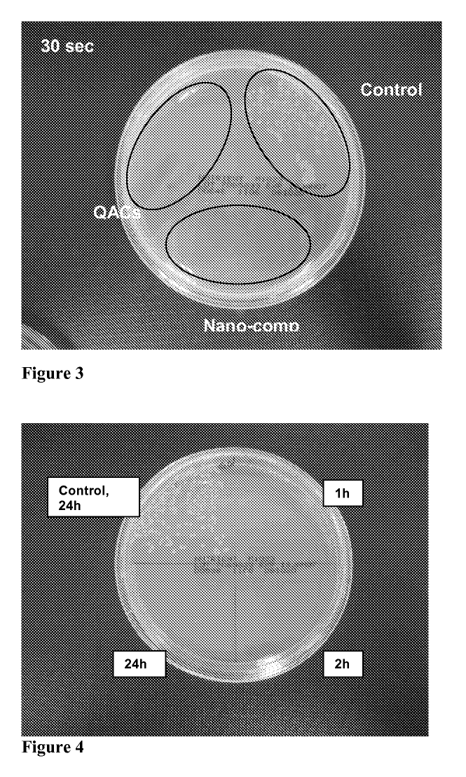

The longevity of the nanocomposites compared to that of QACs was experimentally evaluated. 0.5 ug of nanocomposites—class 1 (in the form M₇₀N₃₀) solution and 30 ul of nanocomposites—class 2 (in the form L₆₀M₄₀) solution was impregnated on a napkin. A piece of Clorox wet wipe was used for the QACs. 0.5×10⁶ E. coli O157:H7 was spread on the agar plate. The impregnated materials were placed onto the agar. The inspection was conducted after 18 hours of treatment. FIG. 2 shows that the nanocomposites are more efficient in killing bacteria than the QACs when immobilized on a napkin after 18 hours of incubation. The rapidity of the action was demonstrated by immersing the impregnated napkin in water which has a suspension of 0.1×10⁶ bacteria for 30 seconds followed by the incubation of the bacterial solution on an agar plate overnight. FIG. 3 shows that the nano-comp and the QACs are equally efficient in killing bacteria immediately when immobilized in napkin after 30 seconds of incubation.

### EXAMPLE 3

The residual biocidal effect of nanocomposites loaded onto a napkin was studies at various time points on E. coli O157:H7. Napkin coupons were cut and immersed in 250 ul of water or water containing 20 ul biocidal nanocomposites. 1×10⁴ E. coli O157:H7 were inoculated on hard surface and then the inoculated area was wiped for 10 sec with the blank and loaded napkin. After napkin removal, 20 ul of liquid remained in the area after wiping was collected and inoculated on an agar plate (quadrant #2, clockwise, upper-right corner). After 2 h the same area was re-inoculated with the same amount of bacteria. After 20 sec another 20 ul of liquid from the wet surface were collected and inoculated on the agar plate (quadrant #3). The same process was repeated at 24 h and liquid inoculated in quadrant #4. Quadran#1 was inoculated initially with liquid resulted from wiping bacteria with the blank napkin. This quadrant was observed at 24 h and served as a control for the effect of the blank napkin. FIG. 4 clearly shows that the nanocomposites have a residual effect for at least 24 h. Similar studies showed that the residual effect increased depending on the dose of nanocomposites loaded into the napkin.

### EXAMPLE 4

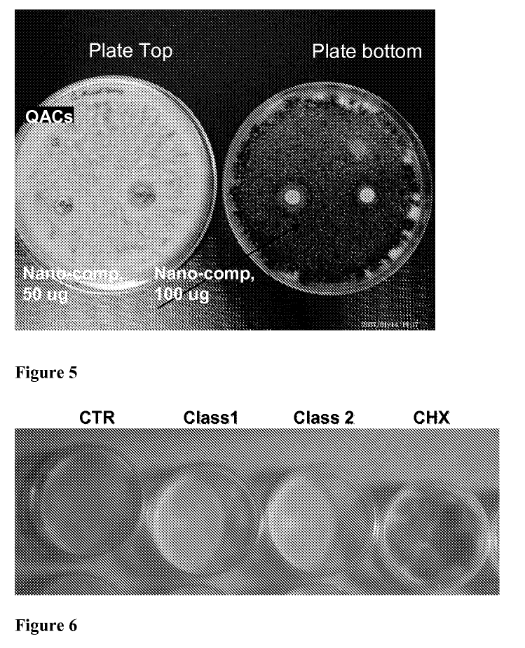

A comparative study between the antifungal and sporicidal effects of nanocomposites and QACs was conducted. 7 mm diameter discs with 50 ug of nanocomposites, 100 ug of nanocomposites, and QACs wipe, respectively, were prepared. 50 ul of spores (bread mold) were inoculated onto potato dextrose agar. The discs were also placed on the agar after the inoculation and the plates incubated to allow for fungal growth. FIG. 5 shows a clear zone of inhibition that resulted after the nanocomposites treatment indicating a sporicidal and antifungal effect. No effect was detected for the QACs. A similar experiment was also conducted to compare the sporicidal and fungicidal effects of two binary classes of nanocomposites with that of Chlorhexidine. FIG. 6 shows that the nanocomposites are far more potent sporicidal and fungicidal agents compared to that of Chlorhexidine.

1. Stable compositions with superior instant and residual bactericidal, virucidal, fungicidal, and sporicidal comprising a combination of elements alloyed or mixed by chemical or physical methods with particulate size varying from 5 nm to 2000 nm.

2. Said compositions in claim 1 are preferably alloyed by green chemical methods or physical methods.

3. Said compositions in claim 1 having a preferred size range between 100 nm and 300 nm.

4. Said compositions in claim 1 are in the form of binary, tri, and quad element alloy compositions of elements such as, but not limited to, Chromium or Manganese or Iron or Cobalt or Nickel or Copper or Zinc, or Silver or Gold, or a rare earth material such as Cerium, or Neodymium, or Samarium, or Gadolinium, or Terbium, or Dysprosium, or Holmium, or Erbium, or Lithium or Sodium, or Potassium, or Magnesium, or Calcium.

5. Said compositions in claim 4 have variations based on weight of each of the elements with a percentage by weight that covers a range of 5% up to 95% for each of the elements in the composition.

6. Said compositions in claim 1 have longevity, and immediate and residual biocidal effects on pathogenic bacteria, viruses, fungi, and spores when used alone or in combinations of compositions.

7. Said stable compositions in claim 1 have instant and residual biocidal effect alone or in combination with other disinfectants such as but not limited to quaternary ammonium compounds (QAC), chlorine-releasing compounds (CRC), triclosan, etc.

8. Said compositions in claim 1 are used as decontaminants via direct application or via a delivery system when they are embedded in a polymeric (e.g. films, sponges, foams, in both flexible and rigid forms) or non-polymeric (e.g. cellulosic structures such as paper, cardboard, napkins, wipes, tissues and fiberglass), woven and non-woven fiber matrices.

9. Said compositions in claim 1 are used to decontaminate surfaces as partially or fully impregnated in absorbent or absorbent materials or when first applied on targeted surfaces and then wiped spread with absorbent or absorbent material.

10. Said compositions in claim 1 are in the form of a liquid or spray or foam which can be applied to the target surface as a liquid spray, or as an aerosol spray, or as a pour-on liquid, or which can be coated or painted on the surface with or without the help of a fiber made out of woven or non-woven, paper, tissue, sponge, foam, or brush element.

11. Said compositions in claim 1 maintain high decontaminant activity over a broad range of pH.

12. Said compositions in claim 1 maintain high decontaminant activity in the presence of organic matter, hard water, detergents, soaps, and surfactants.

13. Said compositions in claim 1 have distinct natural color by virtue of the composition ratio and elements used in the alloys.

14. Said colors of the compositions in claim 13 covers the visible spectrum.

15. Said compositions in claim 1 are responsive to magnetic field with a wide range of Curie temperatures.

16. Said compositions in claim 1 are designed to be non-irritant, non corrosive, non bleaching, non staining and safe for the consumer and environmentally friendly.

17. Said stable compositions in claim 1 remain active during prolonged use as well as prolong storage.

18. Said compositions in claim 1 have superior biocidal properties when used in wet or dry applications.

19. Said compositions in claim 1 have superior biocidal property when used in small concentrations 1-100 ppm and preferably 5-20 ppm.

20. Said compositions in claim 1 maintain superior biocidal properties with multiple usage and they are retrievable and recyclable.
